(19) United States
(12) Patent Application Publication
(10) Pub. No.: US 2023/0220186 A1
(43) Pub. Date: Jul. 13, 2023

(54) LOW-HAZE AND LOW-COLOR PLASTICIZED CELLULOSE ESTER COMPOSITIONS WITH IMPROVED MELT STRENGTH AND ARTICLES FORMED THEREFROM

(71) Applicant: Eastman Chemical Company, Kingsport, TN (US)

(72) Inventors: Robert Erik Young, Kingsport, TN (US); Michael Eugene Donelson, Kingsport, TN (US)

(73) Assignee: Eastman Chemical Company, Kingsport, TN (US)

(21) Appl. No.: 18/000,729

(22) PCT Filed: Jun. 3, 2021
(86) PCT No.: PCT/US2021/035601

§ 371 Date: Dec. 5, 2022

Related U.S. Application Data
(60) Provisional application No. 63/035,902, filed on Jun. 8, 2020.

(51) Int. Cl. C08L 1/12; C08K 3/36; C08K 5/00

(52) U.S. Cl. CPC C08L 1/12; C08K 3/36; C08K 5/0016; C08L 2203/16

(57) ABSTRACT

Disclosed is a plasticized cellulose ester composition. The plasticized cellulose ester composition of the present invention includes a plasticized cellulose ester and an effective amount of an inorganic rheological modifier having a refractive index that differs from the refractive index of said plasticized cellulose ester an amount no more than 0.03 refractive index units. Related articles are also described.

### FIELD OF THE INVENTION

The present invention generally relates to plasticized cellulose ester compositions as well as articles formed from said compositions.

### BACKGROUND OF THE INVENTION

As the chemical industry and consumers look for environmentally friendly alternatives to certain chemicals, the growth of cellulose esters has increased significantly. Cellulose esters are plant-based compounds derived from cellulose, a polysaccharide found in wood, plants and plant products such as cotton. Cellulose esters have been used in a wide variety of consumer and industry end-product uses such as coatings and coating ingredients, objects such as eyeglass frames, disposable knives, forks, spoons, plates, cups and straws, toothbrush handles automotive trim, camera parts and disposable syringes. Cellulose esters also have intermediate and B2B product uses, often in the form of fibers, films, sheets and the like. Published studies indicate that the cellulose esters market is projected to grow from USD 9.27 billion in 2018 to USD 12.43 billion by 2023, at a CAGR of 6% from 2018 to 2023.

One particular polymer encountering lower popularity due to environmental concerns is polyvinylchloride (PVC). PVC had been utilized if not preferred for some time in applications generally requiring flexibility, toughness and visual transparency such as overlay films for identity cards and credit cards and clear outer film layers for wall coverings and flooring; however, its environmental disadvantages make it a candidate for replacement with “greener” materials. Though transitions away from use of PVC are primarily driven by its ecological footprint, it is self-evident that any alternative under consideration must still meet consumer performance expectations to be acceptable. In the applications described above, acceptable alternatives must therefore demonstrate for example low (if not zero) haze and color, visual clarity, high light transmission, flexibility and scratch resistance. WO2018017652A1 and WO2018/089591A1, assigned to the assignee of the present invention, describe and exemplify this assignee's innovations facilitating use of eco-friendly cellulose esters in various applications.

To be suitable, alternative materials must also meet manufacturer expectations such as cost and processability. In this regard, it is acknowledged in the art that challenges exist in utilizing cellulose esters in certain applications. For example, it is noted in U.S. Published Patent Application No. 2016/0068656 that, while cellulose esters are generally considered environmentally-friendly polymers and are derived from renewable sources like wood pulp, they have not been widely used in plastic compositions due to certain processing difficulties. The fact that production of film and sheet with cellulose esters has historically been limited to standard extrusion and solvent casting methods is also discussed in the above-referenced WO2018017652A1, assigned to the assignee of the present invention.

An important characteristic for processability is composition melt strength. Melt strength can be described as the resistance of the composition melt to stretching or breaking under shear force and may be generally related to the molecular chain entanglements of the composition and its resistance to molecular chain untangling under strain. As chain entanglement and untangling resistance increase, melt strength may be improved at low shear rates. A quantitative indicator of melt strength is the complex viscosity of the composition in molten form at low (almost zero) shear, with higher complex viscosity at low shear correlating to higher melt strength, which in turn correlates to improved resistance to sagging during processing, and reduces stretching from roll to roll transfer.

Another characteristic known in the art to be generally relevant to and desirable for processability of a formulation or composition is referred to as “shear thinning”. Shear thinning is generally defined as a change in the viscosity of a fluid when placed under increasing shear strain forces, more particularly the decrease in complex viscosity of a given sample measured from lower shear rates to relatively higher shear rates. Compositions with advantageous levels of shear thinning characteristics can be processed more easily, with lower energy costs and reduced equipment wear, for example in mixing processes to blend and homogenize the composition and processes such as extrusion, injection molding, calendering and the like for forming the composition into useful articles such as films or sheets. Many PVC materials used in flooring, particularly in conjunction with flooring articles or components formed via calendering, typically inherently shear thin during processing. Shear thinning is therefore particularly relevant in the pursuit of compositional alternatives for polyvinylchloride in the resilient flooring market.

Though maximum melt strength is important to processability, it must be carefully balanced with maintaining a composition's decrease in viscosity from shear thinning. Accordingly, compositions useful as PVC alternatives in resilient flooring articles and in particular multilayer resilient flooring articles must exhibit desirably high melt strength while also exhibiting sufficient shear-thinning to be processable (e.g. via extrusion or calendering) into end-use forms such as films or layers. Further, compositions useful as PVC alternatives in the above end uses must be must have low (if not zero) haze and color, visual clarity, high light transmission, flexibility and scratch resistance. Despite advances in the technology, a continuing unmet need remains for compositions that employ environmentally-friendly materials while exhibiting processing and performance characteristics comparable to if not exceeding that of polyvinylchloride.

### SUMMARY OF THE INVENTION

In a first aspect, the present invention relates to a plasticized cellulose ester composition. The plasticized cellulose ester composition of the present invention includes plasticized cellulose ester and an effective amount of an inorganic rheological modifier having a refractive index that differs from the refractive index of the plasticized cellulose ester an amount no more than 0.03 refractive index units.

In another aspect, the present invention relates to an article. The article of the present invention includes an exposed outer surface of a plasticized cellulose ester composition that includes plasticized cellulose ester and an effective amount of an inorganic rheological modifier having a refractive index that differs from the refractive index of the plasticized cellulose ester an amount no more than 0.03 refractive index units.

Further aspects of the invention are as disclosed and claimed herein.

### BRIEF DESCRIPTION OF THE DRAWINGS

FIG. 1 is a side elevational view of an embodiment of a multilayer article of the present invention.

### DETAILED DESCRIPTION

For avoidance of doubt, it is expressly provided for that the information and descriptions herein regarding features or elements of one aspect of the present invention are expressly asserted as applicable to and are relied on to also support those features and elements when described with regard to other aspects of the invention.

In a first aspect, the present invention is directed to a plasticized cellulose ester composition. The plasticized cellulose ester composition of this aspect of the present invention includes plasticized cellulose ester and an effective amount of an inorganic particulate rheological modifier having a refractive index that differs from the refractive index of the plasticized cellulose ester an amount no more than 0.03 refractive index units. The phrase “plasticized cellulose ester” as used herein is intended to describe cellulose ester which has been modified to increase its elasticity or decrease its viscosity, typically but not exclusively by exposing the cellulose ester to a plasticizer. In one or more embodiments, the plasticized cellulose ester composition includes at least one cellulose ester and at least one plasticizer. In one or more embodiments, the inorganic particulate rheological modifier is selected from the group consisting of glass beads, glass fibers, amorphous silica, fumed silica and combinations thereof.

The plasticized cellulose ester composition of the present invention includes plasticized cellulose ester, and preferably includes a cellulose ester and a plasticizer. A cellulose ester is generally defined to include cellulose esters of one or more carboxylic acids and are described for example in U.S. Pat. No. 5,929,229, assigned to the assignee of the present invention, the contents and disclosure of which are incorporated herein by reference. Non limiting examples of cellulose esters include cellulose acetate, cellulose propionate, cellulose butyrate, so-called mixed acid esters such as cellulose acetate propionate and cellulose acetate, and combinations thereof. In one or more embodiments, the at least one cellulose ester is chosen from cellulose acetate, cellulose acetate propionate, or cellulose acetate butyrate and combinations thereof. In one or more embodiments, the cellulose ester is cellulose acetate. In one or more embodiments, the at least one cellulose ester is cellulose acetate propionate. In one or more embodiments, the at least one cellulose ester is cellulose acetate butyrate. In one or more embodiments, the at least one cellulose ester is a combination of cellulose acetate propionate and cellulose acetate butyrate. In one or more embodiments, the cellulose ester has a refractive index of from 1.45 and 1.49.

In one or more embodiments, the amount of cellulose ester in the plasticized cellulose ester composition is between 25% and 99% by weight, or between 35% and 99% by weight, or between 45% and 99% by weight, all based on the total weight of the plasticized cellulose ester composition.

The cellulose ester of the present invention may be characterized using one or more characteristics. For example, in one or more embodiments, the cellulose ester may have a number average molecular weight (“Mn”) that is in the range of from 20,000 Da to 100,000 Da. In one or more embodiments, the cellulose ester has a Mn that is in the range of from about 20,000 Da to about 80,000 Da.

The cellulose ester may have in one or more embodiments a solution ball-drop viscosity of 2 to 30 or 4 to 25 or 5 to 20 seconds as measured by ASTM D817.

The cellulose ester may have in one or more embodiments a degree of substitution of the hydroxyl substituent (DSOH) of from 0.1 to 1.0, or a degree of degree of substitution of the acetyl (DSAC) of from 0.1 to 0.8. By way of brief background, DSOH and DSAC are measures of the degree of esterification for a given cellulose ester. Cellulose has three hydroxyls per anhydroglucose unit, located at the C2, C3 and C6 carbons, that can be esterified to varying degrees and in different ratios with various acyl groups, with the type of cellulose ester formed depending on the functionalization of the hydroxyl groups. For cellulose triacetate, for example, in which substantially all hydroxyl groups of the cellulose functionalized with acetyl groups, the degree of substitution of the acetyl (“DSAC”) is approximately 2.90, and the degree of substitution of the hydroxyl (“DSOH”) is approximately 0.10. Cellulose diacetate has a DSAC of approximately 2.5 and a DSOH of approximately 0.5.

The cellulose ester may in one or more embodiments have a glass transition temperature (Tg) of 50° C. to 150° C. or from 70° C. to 120° C. or no more than 160° C.

The cellulose ester may in one or more embodiments have a percent crystallinity of less than 20% or less than 15% or less than 10% or less than 5% or from 5% to 10% or from 5% to 15% or from 5% to 20% or from 10% to about 20%. Crystallinity is described herein using and measured in the context of the present invention from, the second heat cycle in accordance with ASTM D3418 and assuming an enthalpy of melting of 14 cal/g for the cellulose esters. In this method, the amount of crystallinity is measured under a prescribed heating history, more particularly the “2^{nd} cycle” cooling and heating in a DSC per ASTM D3418. In this method, the sample is first heated in the DSC to above its melting temperature to erase any prior crystallinity (i.e. the “first heat cycle”). Next the sample is cooled at 20 degrees C. per minute to below Tg, and then reheated at the same rate to above the melting temperature again (the “2^{nd} heat cycle”). During this cooling and 2^{nd} heating, the material will recrystallize to a certain degree, and this amount of crystallization is measured in the scan as the enthalpy of melting at the melting temperature.

The plasticized cellulose ester composition of the present invention may further include a plasticizer. In one or more embodiments, the plasticized cellulose ester composition includes from 1% to 35% by weight or from 5% to 30% by weight or from 10% to 30% by weight plasticizer based on the total weight of said composition.

The plasticizer may be any plasticizer known in the art useful for plasticizing cellulose esters, including for example aromatic phosphate ester plasticizer, alkyl phosphate ester plasticizer, dialkylether diester plasticizer, tricarboxylic ester plasticizer, polymeric polyester plasticizer, polyglycol diester plasticizer, polyester resin plasticizer, aromatic diester plasticizer, aromatic triester plasticizer, aliphatic diester plasticizer, carbonate plasticizer, epoxidized ester plasticizer, epoxidized oil plasticizer, benzoate plasticizer, polyol benzoate plasticizer adipate plasticizer, a phthalate plasticizer, a glycolic acid ester plasticizer, citric acid ester plasticizer, hydroxyl-functional plasticizer, solid, non-crystalline resin plasticizer or combinations thereof. In one or more embodiments, the plasticizer is chosen from the group consisting of triethylene glycol 2-ethyl hexanoate, epoxidized soybean oil, acetyl triethyl citrate and combinations thereof.

The plasticized cellulose ester composition of the present invention further includes an inorganic rheological modifier. The phrase “inorganic rheological modifier” is intended to include inorganic materials added to a composition or formulation to impact its flow properties and/or stability. The inorganic rheological modifier has a refractive index that differs from the refractive index of the plasticized cellulose ester an amount no more than 0.03 refractive index units. In one or more embodiments, the plasticized cellulose ester composition of the present invention includes inorganic rheological modifier in an amount of from 0.1% to 15.0% or from 0.5 or from 8% by weight based on the total weight of said composition. In one or more embodiments, the inorganic rheological modifier is an inorganic particulate rheological modifier.

In one or more embodiments, the inorganic rheological modifier is selected from the group consisting of glass beads, glass fibers, amorphous silica, precipitated silica, fumed silica, cristobalite, lithium hydroxide, kuzelite, and combinations thereof. In one or more embodiments, the inorganic rheological modifier includes silica or consists essentially of silica or consists of silica. Suitable silicas include without limitation silicas, fumed silicas, hydrophobic silicas, precipitated silicas, amorphous silicas, microcrystalline silicas and treated silicas. Suitable silicas may be exemplified by silicas commercially available from Evonik under the trade names Aerosil™ R972, Aerosil™ 974, and Aerosil™ R104. The silica may be characterized by one or more of an average particle size from 5 nanometers to as high as 300 microns. Further, the silicas can have a surface area range from 50 to 600 m²/g, or greater than 100 m²/g, or 100 to 600 m²/g, or 105 to 600 m²/g or 110 to 600 m²/g.

In one or more embodiments, the inorganic rheological modifier may also act as a melt-strength-enhancing additive. Melt strength enhancing additives include additives that, when included in a plasticized cellulose ester composition in an effective amount, increase the complex viscosity of the composition as compared to a control of the same composition but without the melt-strength-enhancing additive.

As discussed elsewhere herein, melt strength can be described as the resistance of a composition melt to stretching or breaking under shear force and may be generally related to the molecular chain entanglements of the composition and its resistance to molecular chain untangling under strain. Melt strength may be quantified for example by measuring the complex viscosity of a composition at low, almost no shear. Similarly, improvements or enhancements to melt strength may be quantified for example by measuring the complex viscosity difference between a control and a sample at low shear, almost no shear. For purposes for this application, melt strength enhancement means an increase in complex melt viscosity of a plasticized cellulose ester composition with a melt-strength-enhancing additive versus a control plasticized cellulose ester composition of the same composition but without the melt-strength-enhancing additive when measuring complex viscosity of the compositions as described herein at 1 sec⁻¹.

The composition of the present invention may further include one or more of roll release agents, processing aids, lubricants, waxes, impact modifiers, antioxidants, acid scavengers, flame retardants, lubricants, light stabilizers, ultraviolet stabilizers, dispersing aids, biocides, antistatic agents, water repelling additives, and rodenticides. In one or more embodiments, the plasticized cellulose ester composition of the present invention may include at least one roll release agent. Suitable roll release agents are known in the art and are described for example in U.S. Pat. No. 6,551,688, the contents and disclosure of which are incorporated herein by reference. Examples of suitable roll release agents include without limitation lubricants, exemplified by waxes such as amide waxes, fatty acids, fatty acid esters, fatty acid salts, saponified fatty acid salts and combinations thereof. Examples of a fatty acid esters include esters of montanic acid. In one or more embodiments, the roll release agent is a fatty acid ester selected from the group consisting of butylene glycol ester of montanic acid, glycerol ester of montanic acid, pentaerythritol ester of montanic acid and combinations thereof.

When included in the present invention, the at least one roll release agent is typically present in an amount of 0.1% to about 2.0% by weight based on the total weight of the composition. In one or more embodiments, the at least one roll release agent is present in an amount of 0.1% to 10.0% by weight based on the total weight of the composition. In one or more embodiments, the at least one roll release agent is present in an amount of 0.1% to 0.5% by weight based on the total weight of the composition. In one or more embodiments, the at least one roll release agent is present in amount of 0.5% to 1.0% by weight based on the total weight of the composition. In one or more embodiments, the at least one roll release agent is present in an amount of 1.0% to 2.0% by weight based on the total weight of the composition. In one or more embodiments, the at least one roll release agent is present in an amount of 1.5% to 2.0% by weight based on the total weight of the composition.

The present invention may further include at least one processing aid. Processing aids may for example improve the texture and “fusion” of the melt, improve melt strength, reduce composition melting time, reduce overall processing time and help with metal release from calendering rolls. Processing aids are known in the art and may be derived for example from acrylics, and acrylic copolymers although processing aids based on styrenics, carbonates, polyesters, other olefins, and siloxanes are known and commercially available. Suitable processing aids are commercially available and include without limitation Paraloid™ K-125 available from Dow; Kane-Ace® PA-20, PA-610, B622, MR01 and MP90 available from Kaneka Corporation; and Ecdel™ available from Eastman Chemical Company. In one or more embodiments, the at least one processing aid includes one or more of acrylic polymer, an acrylic copolymer, a styrenic polymer, a carbonate polymer, a polyester polymer, an olefin polymer and a siloxane polymer. In one or more embodiments, the at least one processing aid is selected from the group consisting of an acrylic polymer or an acrylic copolymer. In one embodiment, the processing aid comprises a Kane-Ace® acrylic processing aid.

The amount of the at least one processing aid present in the present invention may vary depending on, the type of processing aid and its molecular weight and viscosity, the other components of the composition and the composition's end-use application. In one or more embodiments, the at least one processing aid is present in an amount of 0% to about 3.0% by weight based on the total weight of the composition. In one or more embodiments, the at least one processing aid is present in an amount of 0.1% to 6.0% by weight based on the total weight of the composition. In one or more embodiments, the at least one processing aid is present in an amount of 0.5% to 6.0% by weight based on the total weight of the composition. In one or more embodiments, the processing aid is present in an amount of 0.5% to 3.0% by weight based on the total weight of the composition.

The present invention may also include at least one impact modifier. Examples of impact modifiers include core-shell polymers based on acrylics, including acrylic polymers, methacrylate butadiene styrene (MBS) polymers, silicone-acrylic polymers and combinations thereof. Other suitable impact modifiers include acrylonitrile-butadiene styrene (ABS), ethylene vinyl acetate copolymers, chlorinated polyethylenes, ethylene copolymers and combinations thereof. The at least one impact modifier, if present, is typically present in an amount of 1% to about 20% by weight based on the total weight of the composition.

The composition of the present invention may further include one or more other ingredients or components such as for example fillers such as calcium carbonate, glass beads and glass fibers; flame retardants, stabilizers such as light and UN stabilizers and absorbers, lubricants, pigments, dispersing aids, biocides, antistatic agents, water repelling additives, rodenticides, dyes, colorants and the like. In one or more embodiments, the composition of the present invention includes a benzotriazole ultraviolet stabilizer. A suitable benzotriazole ultraviolet stabilizer is commercially available from Solvay under the trade name Cyasorb™ 5411. The benzotriazole ultraviolet stabilizer may be present in an amount of 0.2% to 3% by weight based on the total weight of the composition.

An important feature of the plasticized cellulose ester composition of the present invention is its utility in articles such as sheets, films, calendered films, multilayer articles and resilient multilayer flooring articles where minimum visual distortion and maximum visual clarity is desired. Accordingly, in one or embodiments, the plasticized cellulose ester composition exhibits a haze as measured according to ASTM D65/10 of no more than 12.5% or no more than 15%, or no more than 20%, or no more than 25%. In one or more embodiments, the plasticized cellulose ester composition exhibits a CIELAB b* value of less than 2.5, or less than 3, or less than 4, or less than 2, or less than 1.5, or less than 1. In one or more embodiments, the plasticized cellulose ester composition exhibits total light transmission as measured under ASTM D65/10 of at least 85%, or at least 90%, or at least 95%.

Ancillary to the above, another important feature of the plasticized cellulose ester composition of the present invention is its ability to retain maximum visual clarity and minimum visual distortion over time, i.e. by resisting abrasion and scratching, when employed in articles such as sheets, films, calendered films, multilayer articles and resilient multilayer flooring articles where minimum visual distortion and maximum visual clarity is desired.

Another important feature of the plasticized cellulose ester composition of the present invention is its surprising improvement in melt strength as demonstrated by its unexpectedly higher complex viscosity when compared to a control. The is particularly to enhance melt strength while also having low haze and color as several applications benefit from high optical clarity. In general, the absolute level of low-shear viscosity can dictate the temperature required to process a sample. To demonstrate the surprising melt strength characteristics of the plasticized cellulose ester compositions of the present invention, Applicants herein compare the complex viscosity in Poise for the compositions of the present invention, measured at a shear rate of 1 sec⁻¹, to a control resin, which compositionally matches the inventive cellulose ester compositions with the exception of the presence of a melt-strength-enhancing additive. A quantitative calculation for this comparison can be Melt Strength Enhancement, or “MSE”, which may be calculated according to the following equation:

MSE(%)=[(V1−V2)/V2]×100

wherein V1 is the complex viscosity in Poise at a shear rate of 1 sec-1 for an inventive composition (such compositions shown as Formulations and Samples 1-12 and 14 in the Tables below) and V2 is the complex viscosity in Poise at a shear rate of 1 sec⁻¹ for a the control composition (shown as Formulation and Sample 13 in the Tables below). A positive MSE (%) indicates the material has improved melt strength and is for example more resistant to sagging during processing versus control. The shear rate may be measured according to ASTM D-4440 at a temperature of 185° C. In one or more embodiments, the plasticized cellulose ester compositions of the present invention exhibit an MSE of at least 2% or at least 3% or at least 12%

Another important feature of the plasticized cellulose ester composition of the present invention is its unexpected level of shear thinning. Shear-thinning is a characteristic of fluids such as compositions and formulations in which the fluid's complex viscosity decreases as the fluid is subjected to increasing shear rate forces. As mentioned above, shear thinning is the change in complex viscosity of a given sample from lower shear rates to relatively higher shear rates. It is possible to quantify shear thinning by comparing a composition's complex viscosity at a relatively low shear rate to its complex viscosity at a relatively higher shear rate. To demonstrate the surprising shear-thinning characteristics of the plasticized cellulose ester compositions of the present invention, Applicants herein compare the complex viscosity in Poise at a shear rate of 1 sec⁻¹ to the complex viscosity in Poise at a shear rate of 400 sec⁻¹ to determine a Total Complex Viscosity Reduction (TCVR) according to the following equation:

TCVR (%)=[(V1−V2)/V1]×100

wherein V1 is the complex viscosity in Poise of the composition at a shear rate of 1 sec⁻¹ and V2 is the complex viscosity of the composition at a shear rate of 400 sec⁻¹. The shear rate may be measured according to ASTM D-4440 at a temperature of 185° C. Higher TCVR values are indicative of a higher level of shear-thinning. In one or more embodiments, the plasticized cellulose ester composition of the present invention exhibits a total complex viscosity reduction (TCVR) of at least 80% or at least 85% or at least 89% or at least 90% or at least 91%.

In one or more embodiments, the plasticized cellulose ester composition of the present invention exhibits a melt strength enhancement (MSE) of at least 3% or at least 15% or at least 45% and a total complex viscosity reduction (TCVR) of at least 89% or at least 90% or at least 91%.

The plasticized cellulose ester composition of the present invention is suitable for or capable of forming many useful articles. Accordingly, in an aspect, the present invention relates to an article with an exposed surface of a plasticized cellulose ester composition, said composition comprising a plasticized cellulose ester and an effective amount of an inorganic rheological modifier having a refractive index that differs from the refractive index of said plasticized cellulose ester an amount no more than 0.03 refractive index units. In one or embodiments, the article is a multilayer article including at least one exposed layer or a top layer of a plasticized cellulose ester composition, said composition comprising a plasticized cellulose ester and an effective amount of an inorganic rheological modifier having a refractive index that differs from the refractive index of said plasticized cellulose ester an amount no more than 0.03 refractive index units. In one or more embodiments, the article is a calendered article such as sheet or film formed from a plasticized cellulose ester composition, said composition comprising a plasticized cellulose ester and an effective amount of an inorganic rheological modifier having a refractive index that differs from the refractive index of said plasticized cellulose ester an amount no more than 0.03 refractive index units. In one or more embodiments discussed in greater detail below, the article is a flooring article such as a multilayer resilient flooring article with a top layer or wear layer of a plasticized cellulose ester composition, said composition comprising a plasticized cellulose ester and an effective amount of an inorganic rheological modifier having a refractive index that differs from the refractive index of said plasticized cellulose ester an amount no more than 0.03 refractive index units. As previously noted, information and descriptions set forth herein in regard to features and elements of the plasticized cellulose ester composition aspect of the present invention or other aspects are intended to be applicable to and fully support this article aspect or other aspects.

By use of the phrase “calendered article” the present invention intends to describe articles such as films or sheets formed using a calendering method with a molten polymer wherein the molten polymer is forced through the nips of counterrotating rolls to form a film or sheet and gradually squeezed down to a film or sheet of final thickness by optionally passing through additional rolls having a similar counterrotating arrangement (with the roll arrangements typically referred to as a “stack”). The film or sheet may be subjected to additional treatment, such as for example stretching, annealing, slitting or the like, with the final article then wound on a winder. Calendering and calendered articles as used herein are described in more detail in U.S. Published Patent Application No. 2019/0256674, assigned to the assignee of the present invention, the contents and disclosure of which are incorporated herein by reference.

In one or more of these embodiments, the plasticized cellulose ester composition has a melt viscosity according to ASTM 3835 of 1000 Poise to 5000 Poise or 2000 Poise to 5000 Poise at a temperature of 190° C. and a shear rate of 628 s⁻¹. In one or more of these embodiments, the plasticized cellulose ester composition of the present invention is capable of being calendered at the temperature range of the sum of the glass transition temperature of the cellulose ester of the composition minus 20° C. to the sum of the glass transition temperature of the cellulose ester of the composition plus 50° C. With a view toward these embodiments, an aspect of the present invention is a calendered article formed from the plasticized cellulose ester composition of the present invention, particularly wherein the calendered article is a film or sheet and more particularly wherein the calendered article is a sheet or film that useful as of that forms a layer of a multilayer resilient flooring article.

Though an aspect of the present invention describes a utility of the plasticized cellulose ester composition of the present invention in the field of calendering and calendered articles, one of ordinary skill in the art will appreciate that the composition of the present invention may also be useful in forming articles by other known methods, such as for example extrusion, injection molding, blow-molding, additive manufacturing (3D printing), profile extrusion, blown film, multilayer film, sheet lamination and the like. Further, though an aspect of the present invention describes a utility as an exposed surface of article in view of the composition's low-haze, low-color, high light transmission, scratch resistance and other features, one of ordinary skill in the art will appreciate that the composition of the present invention may also be useful for non-exposed or interior surfaces or components of articles, such as for example interior or internal layers of multilayer articles.

The plasticized cellulose ester composition of the present invention may be useful in forming a flooring article, a calendered flooring article or more particularly a layer of a flooring article or a calendered layer of a flooring article. Accordingly, in another aspect, the present invention is directed to a flooring article. The flooring article of this aspect of the present invention includes at least one layer. In one or more embodiments, the at least one layer is a calendered layer. In one or more embodiments, the at least one layer is formed from the plasticized cellulose ester composition of the present invention. Accordingly, the at least one layer includes a plasticized cellulose ester composition, said composition comprising a plasticized cellulose ester and an effective amount of an inorganic rheological modifier having a refractive index that differs from the refractive index of said plasticized cellulose ester an amount no more than 0.03 refractive index units. Flooring articles contemplated as within the scope of present invention include without limitation any material or construction intended for use as, installation on or application to a walking surface or lower surface of a room or building. Non-limiting examples of flooring articles include rolled flooring, squares, tiles, planks, sheet, laminates and the like which may be installed for example as a so-called “floating” floor or a glued-down floor assembly. As previously noted, information and description set forth in regard to features and elements of the plasticized cellulose ester composition aspect or other aspects of the present invention are applicable to and intended to fully support this aspect directed to flooring articles.

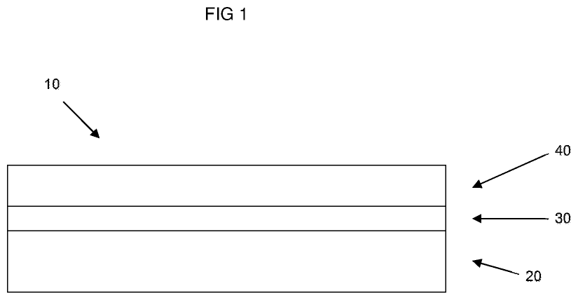

In one or more embodiments, the flooring article is a resilient flooring article. In one or more embodiments, the resilient flooring article is a multilayer resilient flooring article or a laminated flooring article. In a non-limiting exemplary embodiment of a multilayer resilient flooring article depicted in FIG. 1, the multilayer resilient flooring article 10 of the present invention includes a core layer 20 and a top layer 40. The multilayer resilient flooring article may also include an optional print layer 30 between the core layer 20 and the top layer 40. The top or wear layer 40 provides scratch and abrasion resistance while also allowing for visibility through the top surface of any underlying print layer design and typically has a thickness of between 15 mils and 25 mils. The base or core layer 20 provides dimensional stability and typically has a thickness of a thickness of at least 75 mils. The print layer 30 may provide a visual color and/or design, for example in the form of geometric patterns or images, and typically has a thickness of between 3 mils and 5 mils. As discussed elsewhere herein, the core layer 20, top layer 40 and print layer 30 may each be a calendered sheet or a calendered film. Other optional layers, such as removable backing layers, adhesive layers and the like, may also be included. Multilayer resilient flooring articles on the type contemplated herein are generally known in the art and are described for example in U.S. Pat. No. 8,071,193, the contents and disclosure of which are incorporated herein by reference.

In one or more embodiments, the flooring article of the present invention may be a multilayer resilient flooring article that includes at least one layer of the plasticized cellulose ester composition of the present invention. In one or more embodiments, the at least one layer is a calendered layer or a calendered sheet or a calendered film. In one or more embodiments, the flooring article of the present invention may be a multilayer resilient flooring article that includes a top layer or a wear layer of the plasticized cellulose ester composition of the present invention, or a plasticized cellulose ester composition comprising a plasticized cellulose ester and an effective amount of an inorganic rheological modifier having a refractive index that differs from the refractive index of said plasticized cellulose ester an amount no more than 0.03 refractive index units. As discussed previously, the composition of the present invention's low-haze, low-color, high light transmission, scratch resistance and other characteristics are effectively utilized as the top or wear layer of the multilayer resilient flooring article, one of ordinary skill in the art will appreciate that the composition of the present invention may also be utilized as a print layer and/or a core layer of a multilayer resilient flooring article.

### SPECIFIC EMBODIMENTS

Embodiment 1. A plasticized cellulose ester composition, said composition comprising a plasticized cellulose ester and an effective amount of an inorganic rheological modifier having a refractive index that differs from the refractive index of said plasticized cellulose ester an amount no more than 0.03 refractive index units. Embodiment 2. The plasticized cellulose ester composition of Embodiment 1 wherein said composition includes at least one cellulose ester and at least one plasticizer. Embodiment 3. The plasticized cellulose ester composition of Embodiment 2 wherein said composition comprises from 1% to 35% by weight of plasticizer based on the total weight of said composition. Embodiment 4. The plasticized cellulose ester composition of any one of Embodiments 2-3 wherein said composition comprises from 5% to 30% by weight of plasticizer based on the total weight of said composition. Embodiment 5. The plasticized cellulose ester composition of any one of Embodiments 1-4 wherein said inorganic rheological modifier is selected from the group consisting of amorphous silica, precipitated silica, fumed silica, glass beads, glass fiber. Embodiment 6. The plasticized cellulose ester composition of Embodiment 5 wherein said inorganic rheological modifier is silica. Embodiment 7. The plasticized cellulose ester composition of Embodiment 6, wherein the silica has a specific surface area of 100 to 600 m²/g. Embodiment 8. The plasticized cellulose ester composition of any one of Embodiments 6-7 comprising silica in an amount of from 0.25% to 10.0% by weight based on the total weight of said composition. Embodiment 9. The plasticized cellulose ester composition of any one of Embodiments 2-8 wherein said plasticizer is selected from the group consisting of triethylene glycol 2-ethyl hexanoate, dioctyl adipate, di-n-hexyl azelate, epoxidized soybean oil, acetyl triethyl citrate and combinations thereof. Embodiment 10. The plasticized cellulose ester composition of any one of Embodiment 2-9 wherein said composition further comprises one or more of roll release agents, processing aids, lubricants, waxes, impact modifiers, antioxidants, acid scavengers, flame retardants, lubricants, light stabilizers, ultraviolet absorber, dispersing aids, biocides, antistatic agents, water repelling additives, and rodenticides. Embodiment 11. The plasticized cellulose ester composition of any one of Embodiments 2-10 wherein said at least one cellulose ester is selected from the group consisting of cellulose acetate propionate, cellulose acetate butyrate and combinations thereof. Embodiment 12. The plasticized cellulose ester composition of any one of Embodiment 1-11 wherein said plasticized cellulose ester composition exhibits a haze as measured according to ASTM E1348 of no more than 20%. Embodiment 13. The plasticized cellulose ester composition of any one of Embodiment 1-12 wherein said plasticized cellulose ester composition exhibits a CIELAB b* value of no more than 3 units. Embodiment 14. The plasticized cellulose ester composition of any one of Embodiment 1-13 wherein said plasticized cellulose ester composition exhibits total light transmission as measured under ASTM E1348 of at least 86%. Embodiment 15. A multilayer resilient flooring article that includes a wear layer of the plasticized cellulose ester composition of any one of Embodiments 1-13. Embodiment 16. An article with an exposed surface of the plasticized cellulose ester composition of any one of Embodiments 1-13. Embodiment 17. A multilayer article that includes an outer layer of the plasticized cellulose ester composition of any one of Embodiments 1-13. Embodiment 18. A calendered article formed from the composition of any one of Embodiment 1-13. Embodiment 19. The calendered article of Embodiment 18 wherein said calendered article is a sheet or film. Embodiment 20. The calendered article of Embodiment 19 wherein said sheet or film is suitable for use as a wear layer of a multilayer resilient flooring article. Embodiment 21. The plasticized cellulose ester composition of Embodiment 11, wherein the at least one cellulose ester is cellulose acetate propionate.

The following examples, while provided to illustrate with specificity and detail the many aspects and advantages of the present invention, are not be interpreted as in any way limiting its scope. Variations, modifications and adaptations which do depart from the spirit of the present invention will be readily appreciated by one of ordinary skill in the art.

### Sample Preparation

Table 1 provides the additives used to prepare the formulations.

TABLE 1

| | | BET | particle size |
|---|---|---|---|
| Additive | Type | (sq m/g) | (micron) |
| Aerosil ® R972 Silica | Silica | 110 | 0.016 |
| Aerosil ® R974 Silica | Silica | 200 | 0.012 |
| Mistron ® ZSC Talc | Talc | N/A | 2 |
| Cloisite ® 11B | Clay | N/A | 40 |
| Aerosil ® I R104 Silica | Silica | 150 | <1 |
| Sipernat ® 50S Silica | Silica | 500 | 18 |
| Sipernat ® 500LS Silica | Silica | 500 | 10.5 |
| Sipernat ® 50 Silica | Silica | 500 | 50 |
| Sipernat ® 340 Silica | Silica | 175 | 20 |
| Spheilex ® 30AB Silica | Silica | 100 | 4 |

To demonstrate the present invention, several samples of the inventive plasticized cellulose ester composition were formulated and included plasticized cellulose ester with an index of refraction of 1.47 (formed of a cellulose ester plus a plasticizer) and an inorganic rheological modifier with an index of refraction of 1.46. A control composition was also prepared in which the inorganic rheological modifier was omitted. Details regarding each inventive composition as well as the control are set forth in Table 2 below, with the control identified as sample 1 and the inventive compositions identified as samples 2, 3, 4, 5, 6, and 9-17.

TABLE 2

| | Formulation Number | | | | | | | | |
|---|---|---|---|---|---|---|---|---|---|
| Ingredient | 1 | 2 | 3 | 4 | 5 | 6 | 7 | 8 | 9 |
| CAP 482-20 (%) | 75 | 74 | 71 | 69 | 67 | 71 | 73 | 73 | 71 |
| TEG-2EH (%) | 22 | 22 | 22 | 22 | 22 | 22 | 22 | 22 | 22 |
| Kaneka PA 20 (%) | 2 | 2 | 2 | 2 | 2 | 2 | 2 | 2 | 2 |
| Licowax OP (%) | 1 | 1 | 1 | 1 | 1 | 1 | 1 | 1 | 1 |
| Aerosil ® R972 Silica (%) | 0 | 1 | 4 | 6 | 8 | 0 | 0 | 0 | 0 |
| Aerosil ® R974 Silica (%) | 0 | 0 | 0 | 0 | 0 | 4 | 0 | 0 | 0 |
| Mistron ® ZSC Talc (%) | 0 | 0 | 0 | 0 | 0 | 0 | 2 | 0 | 0 |
| Cloisite ® 11B (%) | 0 | 0 | 0 | 0 | 0 | 0 | 0 | 2 | 0 |
| Aerosil ® I R104 Silica (%) | 0 | 0 | 0 | 0 | 0 | 0 | 0 | 0 | 4 |

| | Formulation Number | | | | | | | |
|---|---|---|---|---|---|---|---|---|
| Ingredient | 10 | 11 | 12 | 13 | 14 | 15 | 16 | 17 |
| CAP 482-20 (%) | 71 | 71 | 71 | 71 | 71 | 71 | 71 | 71 |
| TEG2EH (%) | 22 | 22 | 22 | 22 | 22 | 22 | 22 | 22 |
| Kaneka PA 20 (%) | 2 | 2 | 2 | 2 | 2 | 2 | 2 | 2 |
| Licowax OP (%) | 1 | 1 | 1 | 1 | 1 | 1 | 1 | 1 |
| Aerosil ® R972 Silica (%) | 4 | 0 | 0 | 0 | 0 | 0 | 0 | 0 |
| Cloisite ® 11B (%) | 0 | 4 | 0 | 0 | 0 | 0 | 0 | 0 |
| Aerosil ® R104 Silica (%) | 0 | 0 | 4 | 0 | 0 | 0 | 0 | 0 |
| Sipernat ® 50S Silica (%) | 0 | 0 | 0 | 4 | 0 | 0 | 0 | 0 |
| Sipernat ® 500LS Silica (%) | 0 | 0 | 0 | 0 | 4 | 0 | 0 | 0 |
| Sipernat ® 50 Silica (%) | 0 | 0 | 0 | 0 | 0 | 4 | 0 | 0 |
| Sipernat ® 340 Silica (%) | 0 | 0 | 0 | 0 | 0 | 0 | 4 | 0 |
| Spheilex ® 30AB Silica (%) | 0 | 0 | 0 | 0 | 0 | 0 | 0 | 4 |

Regarding the components listed in Table 2: CAP 482-20 is a high viscosity Cellulose Acetate Proprionate available from Eastman Chemical Company with a solution ball-drop viscosity of 20 seconds as measured by ASTM D817. Triethylene glycol bis (2-EthylHexanoate) (TEGEH) is a plasticizer available from Eastman Chemical Company. PA20™ is a Kane-Ace® medium molecular weight process aid available from Kaneka. Licowax™ OP is a wax, more particularly a partially saponified calcium salt of montanic acids and is available from Clariant Corporation. Cloisite® 11B, Cloisite® is a clay available from Byk-Chemie. ZSC Talc is a talc available from Imerys. Aerosil® R972 Silica, Aerosil® R974 Silica, Aerosil® R104 Silica, Sipernat® 50S Silica, Sipernat® 500LS Silica, Sipernat® 340 Silica, Spheilex® 30AB Silica are silicas available from Evonik.

To form each of the formulations, ingredients were weighed at the percentages indicated in Table 2 formulations on a Toledo-Mettler top loading balance to a total mass of 150 grams, placed in a polyethylene bag and then shaken until the mixture visually appeared to be uniform. Samples were then melt blended on a Brabender lab mixer at 170 degrees C. and rpm of 60 for a time of 4 minutes. Samples were then processed on a Dr. Collin Two Roll Mill with the front-roll temperature set at 170° C., the back-roll temperature set at 165° C. and the roll speed set at 10 rpm a sufficient time for the powdered material to achieve a plastic form (and the time was recorded). The resulting plastic material was then removed from the mill as a continuous film of 0.010″ (250 microns) thickness and allowed to cool. Complex viscosity was measure at 185° C. at shear rates from 1 to 400 1/s according to ASTM D4440. Color, Haze and Light transmission was measured according to ASTM E1348 using a D65 illuminant and a 10° observer

### Analytical Methods

Each of the samples prepared above and listed in the Table 2 were tested for complex viscosity (in Poise) according to ASTM D-4440 at shear rates starting at 1 sec⁻¹ and then at increasing shear rates to a shear rate of 400 sec⁻¹. Test temperature was held constant at 185° C. The results of the complex viscosity testing are set forth in Table 3 below. TCVR and MSE values for each sample were calculated according to the equations set forth herein and are set forth in Table 4 below.

An important feature of the plasticized cellulose ester composition of the present invention is its surprising improvement in melt strength as demonstrated by its unexpectedly higher complex viscosity when compared to a control. In general, the absolute level of low-shear viscosity can dictate the temperature required to process a sample. To demonstrate the surprising melt strength characteristics of the plasticized cellulose ester compositions of the present invention, Applicants herein compare the complex viscosity in Poise for the compositions of the present invention, measured at a shear rate of 1 sec⁻¹, to a control resin, which compositionally matches the inventive cellulose ester compositions with the exception of the presence of a melt-strength-enhancing additive. A quantitative calculation for this comparison can be Melt Strength Enhancement, or “MSE”, which may be calculated according to the following equation:

MSE(%)=[(V1−V2)/V2]×100

wherein V1 is the complex viscosity in Poise at a shear rate of 1 sec-1 for an inventive composition (such compositions shown as Formulations and Samples 1-12 and 14 in the Tables below) and V2 is the complex viscosity in Poise at a shear rate of 1 sec⁻¹ for the control composition (shown as Formulation and Sample 13 in the Tables below). A positive MSE (%) indicates the material has improved melt strength and is for example more resistant to sagging during processing versus control. The shear rate may be measured according to ASTM D-4440 at a temperature of 185° C. In one or more embodiments, the plasticized cellulose ester compositions of the present invention exhibit an MSE of at least 20% or at least 50% or at least 80%.

Another important feature of the plasticized cellulose ester composition of the present invention is its unexpected level of shear thinning. Shear-thinning is a characteristic of fluids such as compositions and formulations in which the fluid's complex viscosity decreases as the fluid is subjected to increasing shear rate forces. As mentioned above, shear thinning is the change in complex viscosity of a given sample from lower shear rates to relatively higher shear rates. It is possible to quantify shear thinning by comparing a composition's complex viscosity at a relatively low shear rate to its complex viscosity at a relatively higher shear rate. To demonstrate the surprising shear-thinning characteristics of the plasticized cellulose ester compositions of the present invention, Applicants herein compare the complex viscosity in Poise at a shear rate of 1 sec⁻¹ to the complex viscosity in Poise at a shear rate of 400 sec⁻¹ to determine a Total Complex Viscosity Reduction (TCVR) according to the following equation:

TCVR (%)=[(V1−V2)/V1]×100

wherein V₁ is the complex viscosity in Poise of the composition at a shear rate of 1 sec⁻¹ and V₂ is the complex viscosity of the composition at a shear rate of 400 sec⁻¹. The shear rate may be measured according to ASTM D-4440 at a temperature of 185° C. Higher TCVR values are indicative of a higher level of shear-thinning. In one or more embodiments, the plasticized cellulose ester composition of the present invention exhibits a total complex viscosity reduction (TCVR) of at least 80% or at least 85% or at least 89% or at least 90% or at least 91%.

In one or more embodiments, the plasticized cellulose ester composition of the present invention exhibits a melt strength enhancement (MSE) of at least 3%.

TABLE 3

| Shear | Formulation Number | | | | | | | | |
|---|---|---|---|---|---|---|---|---|---|
| Rate | 1 | 2 | 3 | 4 | 5 | 6 | 7 | 8 | 9 |
| (1/sec) | Viscosity (Poise) | | | | | | | | |
| 1.0 | 16907 | 17460 | 17483 | 19367 | 24576 | 17518 | 15976 | 27980 | 18924 |
| 1.6 | 15853 | 16203 | 16377 | 17657 | 21912 | 16292 | 14796 | 25460 | 17476 |
| 2.5 | 14639 | 14833 | 15052 | 15938 | 19403 | 14946 | 13557 | 22801 | 15916 |
| 4.0 | 13310 | 13389 | 13588 | 14228 | 17030 | 13525 | 12259 | 20113 | 14310 |
| 6.3 | 11922 | 11903 | 12094 | 12542 | 14788 | 12086 | 10940 | 17474 | 12686 |
| 10.0 | 10494 | 10406 | 10588 | 10908 | 12688 | 10629 | 9606 | 14923 | 11073 |
| 15.8 | 9058 | 8941 | 9107 | 9342 | 10777 | 9182 | 8290 | 12562 | 9499 |
| 25.1 | 7640 | 7559 | 7675 | 7854 | 8971 | 7770 | 7039 | 10327 | 7987 |
| 39.8 | 6343 | 6243 | 6373 | 6519 | 7348 | 6472 | 5839 | 8332 | 6618 |
| 63.1 | 5138 | 5058 | 5174 | 5295 | 5921 | 5262 | 4753 | 6592 | 5361 |
| 100.0 | 4082 | 4023 | 4121 | 4225 | 4693 | 4198 | 3795 | 5128 | 4262 |
| 158.5 | 3181 | 3140 | 3221 | 3315 | 3659 | 3286 | 2973 | 3922 | 3328 |
| 251.2 | 2434 | 2408 | 2476 | 2556 | 2794 | 2528 | 2289 | 2937 | 2554 |
| 400.0 | 1804 | 1790 | 1846 | 1915 | 2093 | 1885 | 1708 | 2159 | 1903 |

| Shear | Formulation Number | | | | | | | |
|---|---|---|---|---|---|---|---|---|
| Rate | 10 | 11 | 12 | 13 | 14 | 15 | 16 | 17 |
| (1/sec) | Viscosity (Poise) | | | | | | | |
| 1.0 | 18557.7 | 37998.3 | 19329.2 | 19133.7 | 19764.8 | 19567.5 | 19748.5 | 14986.7 |
| 1.6 | 17483.8 | 33930.7 | 17986.9 | 17732.9 | 18401.7 | 18184.7 | 18307 | 14246.6 |
| 2.5 | 16100 | 29669.3 | 16431.7 | 16161.4 | 16810.9 | 16623.6 | 16684.3 | 13291.3 |
| 4.0 | 14551.5 | 25322.2 | 14789.7 | 14553.8 | 15163 | 15008.3 | 15002.7 | 12192.6 |
| 6.3 | 12896.4 | 21427.1 | 13100.6 | 12918.1 | 13469.6 | 13353.1 | 13285.6 | 10995.9 |
| 10.0 | 11206.5 | 17844.3 | 11430.1 | 11274.9 | 11772.7 | 11686.4 | 11566.6 | 9751.9 |
| 15.8 | 9517.02 | 14508.2 | 9795.26 | 9672.4 | 10141.4 | 10050.8 | 9897.0 | 8491.6 |
| 25.1 | 7948.4 | 11603.2 | 8258.14 | 8169.3 | 8540.5 | 8503.5 | 8330.9 | 7264.6 |
| 39.8 | 6492.4 | 9128.5 | 6803.0 | 6743.51 | 7040.1 | 7039.5 | 6849.2 | 6065.3 |
| 63.1 | 5232.0 | 7087.09 | 5500.8 | 5462.4 | 5686.4 | 5719.3 | 5523.5 | 4959.3 |
| 100.0 | 4173.8 | 5468.1 | 4368.3 | 4345.2 | 4509.2 | 4556.1 | 4371.0 | 3981.3 |
| 158.5 | 3287.0 | 4176.3 | 3407.9 | 3399.0 | 3514.1 | 3565.1 | 3409.6 | 3134.6 |
| 251.2 | 2541 | 3155.0 | 2604.2 | 2597.6 | 2669.5 | 2711.3 | 2594.8 | 2413.8 |
| 400.0 | 1926.8 | 2360.1 | 1955.6 | 1967.6 | 2012.1 | 2051.5 | 1960.0 | 1821.9 |

TABLE 4
MSE/TCVR RATIO'S

| Viscosity | Formulation Number | | | | | | | | |
|---|---|---|---|---|---|---|---|---|---|
| Ratio | 1 | 2 | 3 | 4 | 5 | 6 | 7 | 8 | 9 |
| TCVR (%) | 89.3 | 89.7 | 89.4 | 90.1 | 91.5 | 89.2 | 89.3 | 92.3 | 89.9 |
| MSE (%) | 0.0 | 3.3 | 3.4 | 14.5 | 45.4 | 3.6 | −5.5 | 65.5 | 11.9 |

| Viscosity | Formulation Number | | | | | | | |
|---|---|---|---|---|---|---|---|---|
| Ratio | 10 | 11 | 12 | 13 | 14 | 15 | 16 | 17 |
| TCVR (%) | 90 | 87 | 89 | 89 | 89 | 89 | 89 | 90 |
| MSE (%) | 10 | 125 | 14 | 13 | 17 | 16 | 17 | −11 |

Color, transmittance and haze were measured for the film samples using ASTM E1348 having a D65 illuminant and a 10° observer. The results are set forth in Table 5 below. In one or more embodiments, the plasticized cellulose ester composition of the present invention exhibits a CIELAB b* value of less than of at least 2.5. In one or more embodiments, the plasticized the plasticized cellulose ester composition of the present invention exhibits a haze of less than at least 12.5%. In one or more embodiments of the invention, the plasticized cellulose ester composition exhibits a CIELAB b* value of less than 2.5 units, while also having an MSE of at least 3%. In one or more embodiments of the invention, the plasticized cellulose ester composition exhibits a haze of less than 12.5% while also having an MSE of at least 3%. In one or more embodiments of the invention, the plasticized cellulose ester composition exhibits a CIELAB b* value of less than 2.5 units, a haze of less than 12.5%, and a MSE of at least 3%. In one or more embodiments of the invention, the plasticized cellulose ester composition exhibits a CIELAB b* value of less than 3 units, a haze of less than 20%, and a MSE of at least 3%. In one or more embodiments of the invention, the plasticized cellulose ester composition comprises a silica having a surface area of from 105 to 600 m²/g and exhibits a CIELAB b* value of less than 3 units, a haze of less than 20%, and a MSE of at least 3%.

TABLE 5
COLOR AND HAZE

| | | | | | Total | Diffuse |
|---|---|---|---|---|---|---|
| Formu- | | | | Haze | Transmittance | Transmittance |
| lation | L* | a* | b* | % | (%) | (%) |
| 1 | 95.48 | 0.04 | 1.03 | 12.50 | 88.80 | 11.10 |
| 2 | 96.12 | 0.00 | 0.96 | 5.10 | 90.30 | 4.60 |
| 3 | 96.29 | 0.02 | 0.96 | 3.90 | 90.70 | 3.60 |
| 4 | 96.34 | 0.00 | 0.90 | 4.90 | 90.80 | 4.40 |
| 5 | 96.26 | −0.01 | 0.96 | 4.00 | 90.60 | 3.60 |
| 6 | 96.05 | 0.06 | 1.15 | 3.90 | 90.10 | 3.50 |
| 7 | 92.79 | 0.16 | 1.88 | 44.00 | 82.50 | 36.30 |
| 8 | 94.51 | −0.01 | 3.58 | 13.40 | 86.50 | 11.60 |
| 9 | 96.50 | 0.02 | 0.68 | 2.80 | 91.20 | 2.60 |
| 10 | 95.94 | 0.02 | 0.84 | 7.23 | 89.86 | 6.49 |
| 11 | 93.70 | −0.08 | 4.56 | 21.45 | 84.58 | 18.14 |
| 12 | 96.12 | 0.01 | 0.80 | 3.69 | 90.29 | 3.33 |
| 13 | 96.04 | 0.05 | 1.00 | 9.99 | 90.10 | 9.00 |
| 14 | 95.94 | 0.04 | 1.11 | 11.67 | 89.85 | 10.49 |
| 15 | 96.03 | 0.04 | 0.88 | 14.00 | 90.08 | 12.61 |
| 16 | 96.02 | −0.03 | 1.22 | 6.51 | 90.06 | 5.87 |
| 17 | 94.74 | 0.08 | 1.09 | 60.29 | 87.00 | 52.45 |

As demonstrated in the above Tables, the compositions of the present invention unexpectedly achieve a large increase in melt strength (MSE) over the control while also maintaining haze, color, light transmission and shear-thinning (as evidenced by comparable TCVR) characteristics of the control sample.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A plasticized cellulose ester composition, said composition comprising a plasticized cellulose ester and an effective amount of an inorganic rheological modifier having a refractive index that differs from the refractive index of said plasticized cellulose ester an amount no more than 0.03 refractive index units.

2. The plasticized cellulose ester composition of claim 1 wherein said composition includes at least one cellulose ester and at least one plasticizer.

3. The plasticized cellulose ester composition of claim 2 wherein said composition comprises from 1% to 35% by weight of plasticizer based on the total weight of said composition.

4. The plasticized cellulose ester composition of claim 2 wherein said composition comprises from 5% to 30% by weight of plasticizer based on the total weight of said composition.

5. The plasticized cellulose ester composition of claim 1 wherein said inorganic rheological modifier is selected from the group consisting of amorphous silica, precipitated silica, fumed silica, glass beads, glass fiber.

6. The plasticized cellulose ester composition of claim 5 wherein said inorganic rheological modifier is silica.

7. The plasticized cellulose ester composition of claim 6, wherein the silica has a specific surface area of 100 to 600 m²/g.

8. The plasticized cellulose ester composition of claim 6 comprising silica in an amount of from 0.25% to 10.0% by weight based on the total weight of said composition.

9. The plasticized cellulose ester composition of claim 2 wherein said plasticizer is selected from the group consisting of triethylene glycol 2-ethyl hexanoate, dioctyl adipate, di-n-hexyl azelate, epoxidized soybean oil, acetyl triethyl citrate and combinations thereof.

10. The plasticized cellulose ester composition of claim 2 wherein said composition further comprises one or more of roll release agents, processing aids, lubricants, waxes, impact modifiers, antioxidants, acid scavengers, flame retardants, lubricants, light stabilizers, ultraviolet absorber, dispersing aids, biocides, antistatic agents, water repelling additives, and rodenticides.

11. The plasticized cellulose ester composition of claim 2 wherein said at least one cellulose ester is selected from the group consisting of cellulose acetate propionate, cellulose acetate butyrate and combinations thereof.

12. The plasticized cellulose ester composition of claim 1 wherein said plasticized cellulose ester composition exhibits a haze as measured according to ASTM E1348 of no more than 20%.

13. The plasticized cellulose ester composition of claim 1 wherein said plasticized cellulose ester composition exhibits a CIELAB b* value of no more than 2.5 units.

14. The plasticized cellulose ester composition of claim 1 wherein said plasticized cellulose ester composition exhibits total light transmission as measured under ASTM E1348 of at least 86%.

15. A multilayer resilient flooring article that includes a wear layer of the plasticized cellulose ester composition of claim 1.

16. An article with an exposed surface of the plasticized cellulose ester composition of claim 1.

17. A multilayer article that includes an outer layer of the plasticized cellulose ester composition of claim 1.

18. A calendered article formed from the composition of claim 1.

19. The calendered article of claim 18 wherein said calendered article is a sheet or film.

20. The calendered article of claim 19 wherein said sheet or film is suitable for use as a wear layer of a multilayer resilient flooring article.
